(19) United States
(12) Patent Application Publication
(10) Pub. No.: US 2025/0392485 A1
(43) Pub. Date: Dec. 25, 2025

(54) DECENTRALIZED NETWORKING AND COMPUTING

(71) Applicant: INTERGALACTIC LABS INC., San Francisco, CA (US)

(72) Inventors: Micha Anthenor Benoliel, San Francisco, CA (US); Florent Lionel Stroppa, Equemauville (FR); Eliott Quentin Eric Teissonniere, San Francisco, CA (US); Lucien Jean Baptiste Loiseau, San Francisco, CA (US); Garrett Edward Kinsman, San Francisco, CA (US)

(73) Assignee: INTERGALACTIC LABS INC., San Francisco, CA (US)

(21) Appl. No.: 18/879,728

(22) PCT Filed: Jun. 28, 2023
(86) PCT No.: PCT/US2023/026484

§ 371 Date: Dec. 27, 2024

Related U.S. Application Data
(60) Provisional application No. 63/367,212, filed on Jun. 28, 2022.
(60) Provisional application No. 63/503,584, filed on May 22, 2023.

(51) Int. Cl. H04L 9/00

(52) U.S. Cl. CPC H04L 9/50; H04L 2209/56

(57) ABSTRACT

Technology is provided for object validation. A device for object validation may include data processing hardware, and memory hardware in communication with the data processing hardware. The memory hardware may storing instructions that when executed on the data processing hardware may cause the data processing hardware to perform operations including generating a rotating code by combining a private key with metadata. The operations may include computing a proof using the rotating code and an object identifier for an object. The operations may include generating a hash of the proof and the metadata. The operations may include storing the hash in a network-accessible storage device.

### RELATED APPLICATIONS

This application is a national stage of PCT Patent Application No. PCT/US2023/026484, filed on Jun. 28, 2023, which claims the benefit of U.S. Provisional Application No. 63/367,212, filed on Jun. 28, 2022 and U.S. Provisional Application No. 63/503,584, filed on May 22, 2023, the disclosures of which are hereby incorporated by reference in their entirety.

### TECHNICAL FIELD

This disclosure relates to decentralized networking and to decentralized networking and computing including aspects relating to proof of connectivity, location, and origin.

### BACKGROUND

Unless otherwise indicated herein, the materials described herein are not prior art to the claims in the present application and are not admitted to be prior art by inclusion in this section.

The Internet of Things (IoT)—the network of connected “smart” devices that communicate seamlessly over the Internet—is expanding into many aspects of human life. Increasingly, IoT devices are being used for healthcare at hospitals, and in medical device and pharmaceutical manufacturing. In cities, IoT devices may be used to track and monitor pollution. IoT devices may also be used by governments, militaries, companies, and individuals for asset tracking and management. Although these applications serve different purposes, these applications share one characteristic-a dependence on strong connectivity with any number of devices.

The subject matter claimed herein is not limited to implementations that solve any disadvantages or that operate only in environments such as those described above. Rather, this background is only provided to illustrate one example technology area where some implementations described herein may be practiced.

### SUMMARY

A device for object validation may include data processing hardware and memory hardware in communication with the data processing hardware. The memory hardware may store instructions that when executed on the data processing hardware may cause the data processing hardware to perform operations. The operations may include generating a rotating code by combining a private key with metadata, computing a proof using the rotating code and an object identifier for an object, generating a hash of the proof and the metadata, and storing the hash in a network-accessible storage device

A device for object validation may include data processing hardware and memory hardware in communication with the data processing hardware. The memory hardware may store instructions that when executed on the data processing hardware may cause the data processing hardware to perform operations. The operations may include receiving a rotating code and an object identifier for an object, computing a proof using the object identifier and the rotating code, generating a hash of the proof and metadata; and sending the hash for verification of the proof.

A device for object validation may include data processing hardware and memory hardware in communication with the data processing hardware. The memory hardware may store instructions that when executed on the data processing hardware may cause the data processing hardware to perform operations. The operations may include identifying an object identifier for an object; generating a non-fungible token (NFT) based on the object; generating an NFT proof using NFT metadata and the object identifier; and pushing the NFT proof to a blockchain.

The objects and advantages of the disclosure will be realized and achieved at least by the elements, features, and combinations particularly pointed out in the claims. Both the foregoing general description and the following detailed description are given as examples and are explanatory and are not restrictive of the invention, as claimed.

### DESCRIPTION OF DRAWINGS

Examples will be described and explained with additional specificity and detail through the use of the accompanying drawings in which:

FIG. 1 is a schematic view of a network architecture including one or more endpoint devices, one or more intermediate devices, one or more relay servers, and one or more endpoint manager servers in accordance with some implementations of the present disclosure.

FIGS. 2A-2D are schematic views illustrating functionality using a network architecture in accordance with some implementations of the present disclosure.

FIGS. 3A illustrates an example process flow for object validation.

FIG. 3B illustrates an example process flow for object validation using a non-fungible token (NFT).

FIG. 3C illustrates an example process flow for digital image validation using a non-fungible token (NFT).

FIG. 4A illustrates an example process flow for capturing a digital image.

FIG. 4B illustrates an example process flow for validating an object using a blockchain.

FIG. 4C illustrates an example process flow for minting a non-fungible token (NFT).

FIG. 5 illustrates an example flowchart for object validation.

FIG. 6 illustrates an example flowchart for object validation.

FIG. 7 illustrates an example flowchart for object validation.

FIG. 8 is a schematic view illustrating a machine in the example form of a computing device.

### DETAILED DESCRIPTION

Many connectivity solutions exist for Internet of Things (IoT) devices. Unfortunately, many suffer problems of limited bandwidth, decreased connectivity, high power consumption, and/or high cost. For example, cellular connections may consume significant power in a device and may also be expensive. Low power solutions, such as a Low-Power Wide-Area Network (LPWAN) may consume less power than cellular connections. LPWANs, however, may be constrained by limited bandwidth and may not be able to transmit enough data to fully serve the needs of distributed networks. Conventional systems may not consume a relatively low amount of power while still providing high bandwidth.

Furthermore, conventional systems may not provide proof of connectivity which may prevent the validation of activities or participation. For example, proving that a user attended an event, met somebody, listened to a talk, or the like may not be achieved without proving connectivity. Therefore, techniques for establishing connectivity would be useful.

Conventional systems may lack techniques for validating different objects such as digital information and/or media. Digital information may be difficult to validate with the proliferation of artificial intelligence (AI) tools for modifying digital content. For example, digital photos may be generated using AI tools without capturing the corresponding image in a native format. Even when the corresponding image is captured in a native format, the digital image may be modified using AI tools or other digital image editing tools. Furthermore, for creators of digital artwork, correct attribution may be not be simple without an explicit origin. Moreover, distributing a digital image without losing data relating to attestation, authenticity, provenance, or the like may be difficult without a distributed way of verifying a digital image. For example, a digital image may be tampered with. Therefore, devices, systems, and methods for enhancing validation may be useful.

Proving connectivity, authenticity, and/or origin may be achieved in various ways. The proof of location may be used to enhance contextual interactions based on location which may be used for geographic airdrop, governance for local citizens, or the like. The proof may be used to prove the origin and authenticity of a piece of content (e.g., a digital image). In some instances, the proof may be tokenized. For a digital image, proof of authenticity and/or origin may enhance the value of a digital image—which may be viewed as an original negative.

In one example, a device for object validation may include data processing hardware and memory hardware in communication with the data processing hardware. The memory hardware may store instructions that when executed on the data processing hardware may cause the data processing hardware to perform operations. The operations may include generating a rotating code by combining a private key with metadata, computing a proof using the rotating code and an object identifier for an object, generating a hash of the proof and the metadata, and storing the hash in a network-accessible storage device

A device for object validation may include data processing hardware and memory hardware in communication with the data processing hardware. The memory hardware may store instructions that when executed on the data processing hardware may cause the data processing hardware to perform operations. The operations may include receiving a rotating code and an object identifier for an object, computing a proof using the object identifier and the rotating code, generating a hash of the proof and metadata; and sending the hash for verification of the proof.

A device for object validation may include data processing hardware and memory hardware in communication with the data processing hardware. The memory hardware may store instructions that when executed on the data processing hardware may cause the data processing hardware to perform operations. The operations may include identifying an object identifier for an object; generating a non-fungible token (NFT) based on the object; generating an NFT proof using NFT metadata and the object identifier; and pushing the NFT proof to a blockchain.

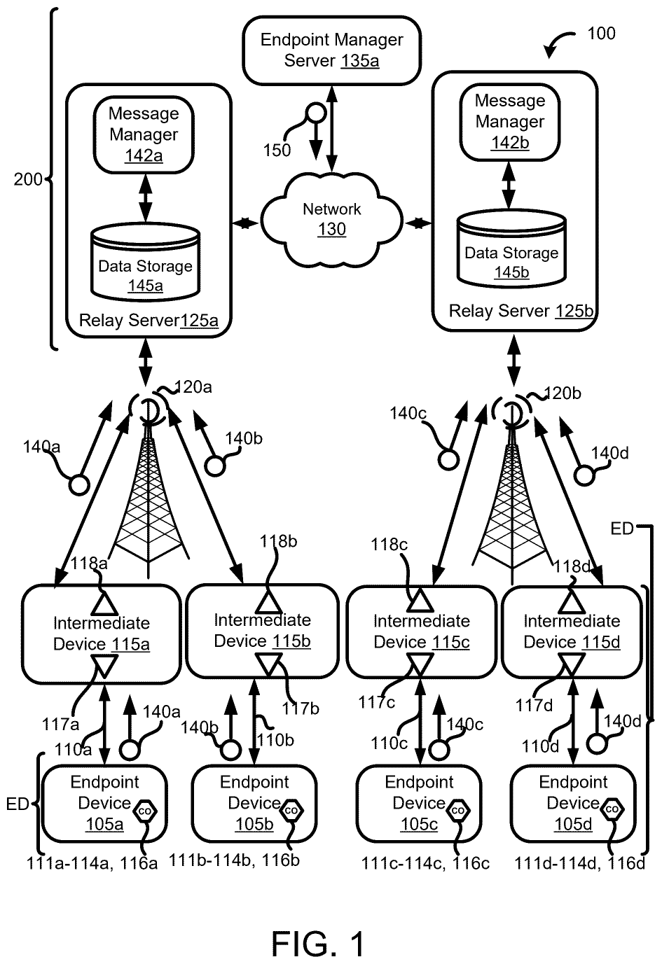

Referring to FIG. 1, in some implementations, an example network architecture 100 may include one or more endpoint devices 105a-d, one or more intermediate devices 115a-d, one or more relay servers 125a-b, and one or more endpoint manager servers 135a. In some implementations, the network architecture 100 is capable of moving or transferring data (e.g., message, desired information, desired measurement data) between one or more endpoint devices 105 and various endpoint manager servers 135a by way of crowd-sourced intermediate devices 115a-d, which can be implemented as network clients, and one or more relay servers 125a-b. In at least one implementations, the one or more endpoint devices 105a-d may be referred to as edge devices (“ED”). In at least one implementation, the one or more endpoint devices 105a-d and the one or more intermediate devices 115a-d may collectively be referred to as edge devices (“EDs”). In some implementations, the network architecture 100 is capable of providing “hotspot” service to one or more of the edge devices ED directly or in-directly. In some implementations, the network architecture 100 is capable of providing “hotspot” service to one or more of the endpoint devices 105a-d using a short-range wireless network.

In some implementations, an endpoint device 105a-d includes one or more Internet of Things (IoT) devices 11a-d1. To support the operation of the IoT device 111a-d, the endpoint device 105a-d may include a power supply 112a-d, a data collection device 113a-d (e.g., sensor, meter, device capable of sensing environment or person), and a network device 114a-d. The power supply 112a-d may include a battery and/or a connection to a power grid. Additionally or alternatively, the power supply 112a-d may include an energy harvesting apparatus, such as a solar panel, solar cell, solar photovoltaic, electromagnetic, etc. In at least some implementations, the endpoint device 105a-d does not include a power supply and use ambient backscatter or other suitable techniques instead to operate the endpoint device 105a-d. The data collection device 113a-d in the endpoint device 105a-d may include one or more sensors. The one or more sensors may be configured to detect any type of condition (e.g., environmental condition, human condition), and generate electronic data based on a detected condition. For example, the endpoint device 105a-d may include a smart watch with a heart rate monitor (configured with the heart rate sensor) that is configured to generate heart rate data based on heart rate conditions collected by the heart rate sensor. In at least one implementation, the endpoint device 105a-d does not have capability to communicate over the Internet and only includes hardware and/or software capable of communicating with nearby devices, such as a nearby intermediate device 115a-d, using one short-range wireless protocol or a combination of short-range wireless protocols. In some implementations, the endpoint device 105a-d includes a data storage which is used to store the condition measurement data. In some implementations, the endpoint device 105a-d is configured to transmit the stored data to a device (e.g., intermediate device 115a-d) when the endpoint device 105a-d is in data communication with the device.

The network device 114a-d of the endpoint device 105a-d may include any suitable hardware, software, or combination thereof that is capable to communicate with another device (e.g., intermediate device 115a-d) via a network. In at least one implementation, the network device 114a-d includes a network controller 116a-d configured to communicate via a short-range network, such as a network implemented with Bluetooth® protocols or any other suitable type of short-range network. In at least one implementation, the network device 114a-d may include a network controller 116a-d configured to communicate via a low-power network (e.g., a suitable network that supports transmit powers from 0.01 mW to 100mW). In some implementations, the network controller 116a-d may be configured to communicate via a low-power and short-range network (e.g., Bluetooth® network). Example endpoint devices 105a-d may include, but are not limited to, industrial devices, residential appliances, commercial equipment, inventory trackers, smart watches, wearables, heart rate monitors, logistics trackers, environmental sensors, cash registers, credit card readers, point-of-sale (POS), bikes, electric scooters, electric skate boards, cars, electric cars, satellites, or any device (mobile and not mobile that includes a wireless radio interface). In accordance with some implementations of the present disclosure, the network architecture 100 may include any number of endpoint devices 105a-d, and the endpoint devices 105a-d in the network architecture 100 may be any type of endpoint device 105a-d, including any type of network-capable device. The endpoint devices 105a-d may be fixed or relatively stationary in the network architecture 100, such as a POS or a pollution sensing device. Additionally or alternatively, the endpoint devices 105a-d may be mobile, such as a smart watch, or any vehicle categories (e.g., car, truck, bike, kickboard).

As illustrated in FIG. 1, in some implementations, the one or more endpoint devices 105a-d may be configured to communicate with other devices (e.g., intermediate devices 115a-d) in the network via at least one first wireless network 110a-d. For example, an endpoint device 105a in FIG. 1 may be in electronic communication (e.g., data communication) with an intermediate device 115a via a first wireless network 110a. The one or more intermediate devices 115a-d may include any kind of device capable of communicating with the endpoint device 105a-d via the first wireless network 110a-d and with the relay server 125a-b via a second network 120a-b. In at least one implementation, the intermediate device 115a-d includes two network controllers: a first network controller 117a-d to communicate via the first wireless network 110a-d and a second network controller 118a-d to communicate via the second network 120a-b. Example intermediate devices 115a-d include personal computers (PC), laptops, smart phones, netbooks, e-readers, personal digital assistants (PDA), cellular phones, mobile phones, tablets, vehicles, drones, cars, trucks, wearable devices, routers, televisions, or set top boxes, etc.

As illustrated in FIG. 1, in some implementations, the first endpoint device 105a may be in electronic communication with the first intermediate device 115a via the first wireless network 110a (e.g., a short-range network with a range between 10 meters and 100 meters). Further, an endpoint device 105b may be in electronic communication with an intermediate device 115b via a first wireless network 110b. An endpoint device 105c may be in electronic communication with an intermediate device 115c via a first wireless network 110c. An endpoint device 105d may be in electronic communication with an intermediate device 115d via a first wireless network 110d.

In some implementations, the first wireless network 110a-d may be any network that consumes or uses a relatively low amount of power (e.g., power between 0.01 mW and 100 mW). At least some example of the first wireless networks 110 include Bluetooth® network (e.g., Bluetooth Low Energy (BLE), Bluetooth 4.0, Bluetooth 5.0, Bluetooth Long Range), NarrowBand-IoT (NB-IoT) network, Long-Term Evolution (LTE) Direct network, LTE for Machines (LTE-M) network, LTE Machine-to-Machine (LTE M2M) network, 5G network, Wireless Fidelity (Wi-Fi) network, Wi-Fi Aware network, or any low-power network and/or short-range network.

As illustrated in FIG. 1, in some implementations, the one or more endpoint devices 105a-d may connect to various intermediate devices 115a-d using different kind of first wireless networks 110a-d. For example, the first endpoint device 105a may be in electronic communication (e.g., data communication) with the first intermediate device 115a via a first wireless network 110a implemented with the BLE, and the second endpoint device 105b may be in electronic communication with the second intermediate device 115b via a first wireless network 110b implemented with other type of the short-range wireless network.

In some implementations, the first wireless network 110a-d and the second network 120a-b are different types of networks. For example, the first wireless network 110 may be a Bluetooth® network and the second network 120a-b may be a cellular network, Wi-Fi, or the Internet. For example, the second network 120a-b may include a public network (e.g., the Internet), a private network (e.g., a local area network (LAN) or wide area network (WAN)), a wired network (e.g., Ethernet network), a wireless network (e.g., an 802.xx network or a Wi-Fi network), a cellular network (e.g., a Long Term Evolution (LTE) or LTE-Advanced network, 1G network, 2G network, 3G network, 4G network, 5G network, etc.), routers, hubs, switches, server computers, and/or a combination thereof.

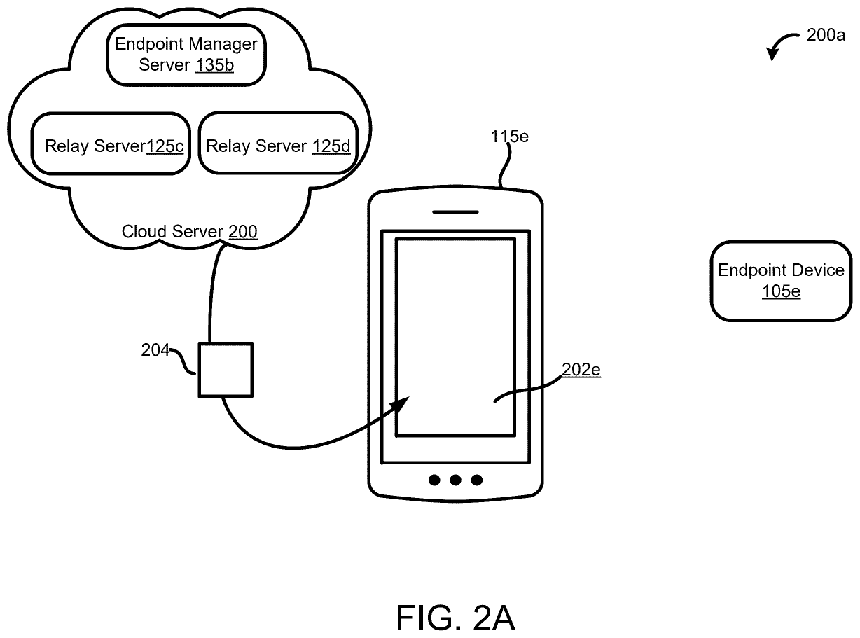

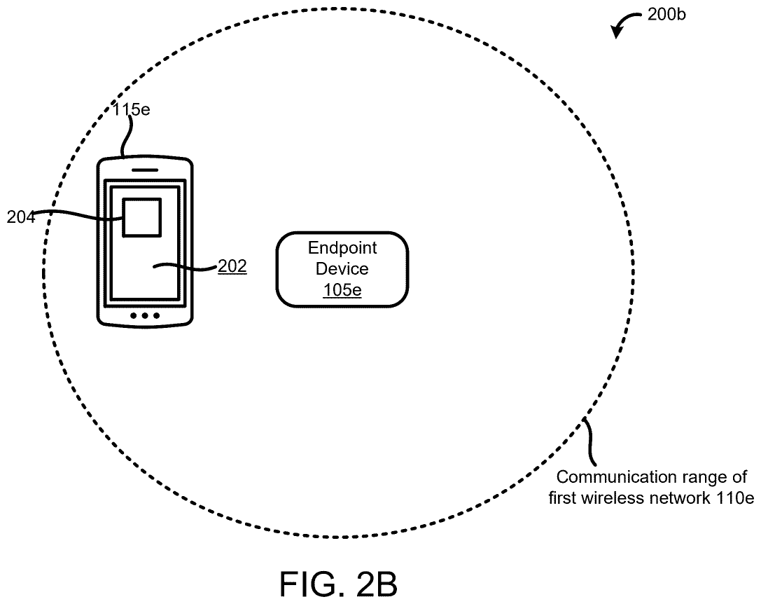

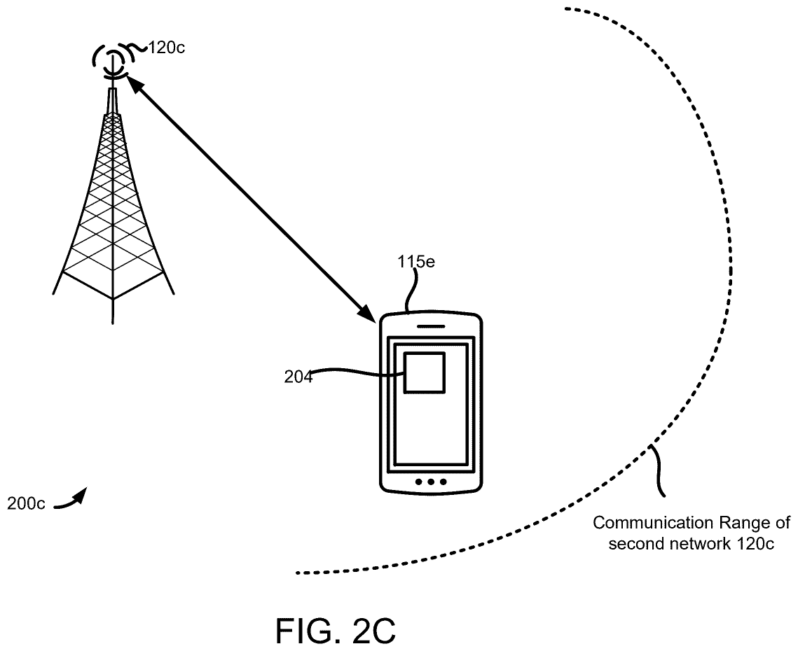

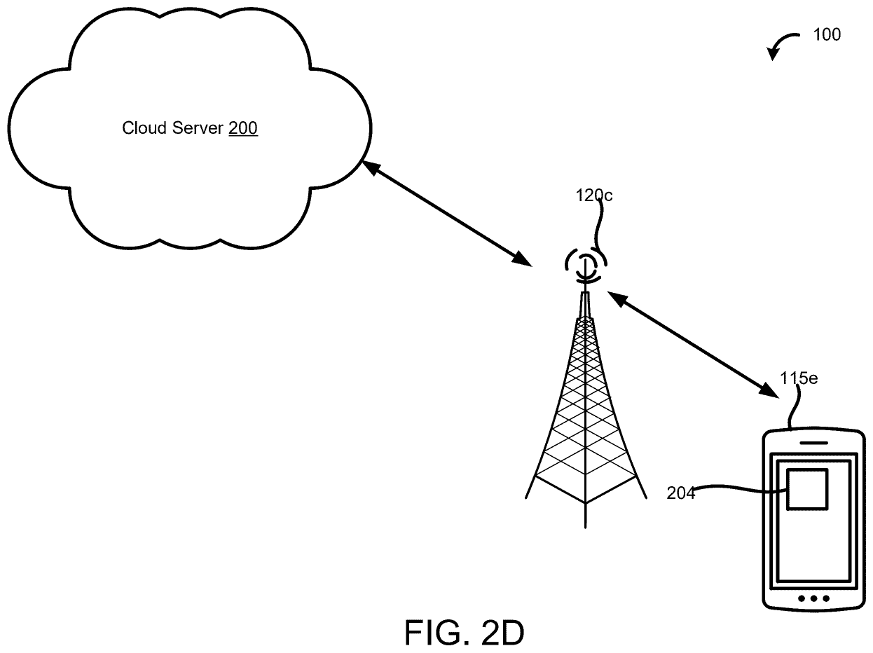

In some implementations, a third network 130, that connects the relay servers 125a-b to the endpoint manager server 135a, may include a public network (e.g., the Internet), a private network (e.g., a local area network (LAN) or wide area network (WAN), a wired network (e.g., Ethernet network), a wireless network (e.g., an 802.xx network or a Wi-Fi network), a cellular network (e.g., a Long Term Evolution (LTE) or LTE-Advanced network, 1G network, 2G network, 3G network, 4G network, 5G network, etc.), routers, hubs, switches, server computers, and/or a combination thereof. In at least one implementation, the second network 120a-b and the third network 130 may be the same network or include at least some overlapping components. In some implementations, at least some portion of the relay servers 125a-b, third network 130, and endpoint manager server 135a may be a cloud server 200 (as illustrated in FIG. 2A and 2D) (e.g., distributed computing network). For example, relay servers 125a-b, third network 130, and endpoint manager server 135a may form a distributed computing network that may interact with the intermediate devices 115a-d and endpoint devices 105a-d. The edge devices ED (e.g., intermediate device 115a-d) may be included in the cloud network 200 for edge devices ED configured to collect and/or process desired data.

Endpoint devices 105a-d, intermediate devices 115a-d, or both, may be fixed, relatively stationary, or moveable. When an endpoint device 105a-d and an intermediate device 115a-d come into wireless range of each other (e.g., 10 meters), the endpoint device 105a-d and the intermediate device 115a-d may perform a handshake and/or authentication to initiate data exchange between the endpoint device 105a-d and the intermediate device 115a-d in accordance with some implementations. For example, an intermediate device 115a-d may be configured to provide “hotspot” service to an endpoint device 105a-d after the authentication. In some implementations, the “hotspot” service may be provided to the endpoint device 105a-d by executing code (e.g., program 204 shown in FIG. 2a) on a virtual environment 202 (shown in FIG. 2a) of the intermediate device 115a-d.

The endpoint device 105a-d may be configured to periodically or randomly send or transmit a beacon signal 140a-d or a beacon signal 140a-d that includes data (e.g., data that identify the transmitting endpoint device 105a-d, data measured or received by the transmitting endpoint device 105a-d) via the first wireless network 110a-d. The endpoint devices 105a-d may include various services that may run on the endpoint devices 105a-d. For example, a smart watch may include a clock service, a heart rate monitor service, a motion detection service, a music service, etc. Separate beacon signals 140a-d may be generated for each of these services or a single beacon signal may be generated to include data for some or all of the services.

In some implementations, a service can execute on-demand Bluetooth Low Energy (BLE) conversations in order to read/write information from/to the endpoint device 105a-d (e.g., IoT device 111a-d in the endpoint device 105a-d). This works by running custom-made code (e.g., instructions or code capable of running on a virtualization environment and/or containerization environment such as bytecode and containerized program) on virtual environment 202 (e.g., virtual machine, container) operating on the edge device ED (endpoint device 105a-d and/or the intermediate device 115a-d). This code (e.g., bytecode, containerized program) is also referred to as a “Smart eXchange” or “SX” in the present disclosure. In some implementations, the virtual environment 202 exposes certain opcode allowing basic networking operations such as BLE read/write, http get/post, or dtn send. Because the virtual environment 202 is turing complete, it is possible to run any kind (or version) of BLE protocol.

The edge devices ED (e.g., the endpoint devices 105a-d and/or the intermediate devices 115a-d) may include circuitry (e.g., hardware, software, or a combination thereof) that may be configured to execute the code (also referred to as “program 204” in this disclosure) locally. In at least one implementation, the circuitry includes the virtual environment 202 where the code is run on. The virtual environment 202 may include an interpreter that can execute a program 204 (e.g., bytecode, containerized program) written in any programming language, such as in Nodle Assembly (NASM). A benefit to the virtual environment 202 residing inside an edge device ED (e.g., the endpoint devices 105a-d and/or the intermediate devices 115a-d) may include an ability to selectively execute the program 204 responsive to one or more predetermined conditions (e.g., trigger event). Additional benefits of the virtual environment 202 residing inside the edge device ED may include that the program 204 can be selectively pushed from the cloud server 200 to edge devices ED-bypassing the conventional application stores (e.g., Play Store by Google, App Store by Apple). Further, the same program 204 can be pushed and installed onto different edge devices ED regardless of version and/or type of the operating system installed on the edge devices ED (e.g., version of Android, or iPhone® operating system (iOS)). However, the present disclosure does not limit that the form of the program 204. The program 204 may be included in a conventional application that is available at the application stores. The program 204 may be included to an operating system of the edge device ED. By executing the program 204, the owner of the edge device ED may receive reward (e.g., cryptocurrency) from the distributor or operator of the program (e.g., author of the program 204).

A program 204 may be configured to cause one edge device ED (endpoint device 105a-d and/or intermediate device 115a-d) to communicate (e.g., sharing, relaying, routing data or message) with another edge device ED (endpoint device 105a-d and/or intermediate device 115a-d) nearby using a short-range wireless network (e.g., first wireless network 110a-d). In a specific example, a group of edge devices ED are selected to have the program 204 installed (relay service program in this example). Based on the program 204, the edge devices ED are configured to provide data and/or message relay service. For instance, an endpoint manager server 135a may send or transmit a message 150 (e.g., advertisement, announcement, information, data, firmware, program 204) to one of the edge devices ED (intermediate device 115a in this example) configured with the program 204. In some implementations, the edge device ED (intermediate device 115a), which received the message 150 from the endpoint manager server 135a, may relay or transmit the message 150 to other edge devices ED nearby (intermediate device 115b in this example) configured with the program 204 via the short-range wireless network (e.g., first wireless network 100a-d). Similarly, the message 150 \may be relayed or propagated from the intermediate device 115b to the intermediate device 115c via the short-range wireless network (e.g., first wireless network 110a-d) and then from the intermediate device 115c to the intermediate device 115d via the short range wireless network (e.g., first wireless network 110a-d). In some implementations, similarly, the message 150 may be transmitted or propagated to nearby endpoint devices 105a-d (endpoint devices 105a-d in this example) installed with the program 204. For example, the message 150 may be relayed or transmitted between the endpoint devices 105a-d nearby. In other words, the message 150 from the endpoint manger server 135a may be delivered to edge devices ED configured with the program 204 in a particular area using the short-range wireless network (e.g., first wireless network 110a-d). In some implementations, each of the intermediate devices 115a-d may receive the message 150 and may relay or transmit the message 150 to endpoint devices 105a-d nearby via the short-range wireless network (e.g., first wireless network 110a-d). In this manner, local, ad-hoc networks of devices may be created.

A server, for example, may push an instruction that may be received by at least one device. That device, may establish a network and may forward the instruction to any other device within range. Those devices may join the network, and can forward the instructions again to other devices within their respective range. In this manner, instructions for creating networks can be propagated. In some examples, the instruction may include a network limiter, which may be geography-based, size-based, number of joined devices-based, time-based, etc. In a geography-based limitation on a network, for example, the instruction may include an identification of a central point for the network, such a global positioning system (GPS) location, latitude/longitude coordinates, etc. and a distance from that central point where the network is permitted. For example, a stadium can be selected as the central point, a distance from that central point, such as a boundary to substantially encompass the stadium, as well as a time in which the network may expire, such as after a sports event. For devices that receive the instruction to join the network, those devices can perform a check first to see if the criteria is met, and if so, those devices can join the network. If at least one of the criteria is not met (e.g., out of range, beyond the time limit, etc.) then the device may not join the network. The potentially joining device, for example, can check its own location (e.g., actual location, distance from the central point, etc.) to see if it is within the range. Devices that join the network, for example, can append data to instructions that are forwarded. For example, a number of devices that are joined can be data included in the instructions and a potentially joining device can check that number versus a total allowable number of devices on the network. That potentially joining device can join the network if there are still available spots for devices and may not join if there are no more available spots. As devices leave the network, other devices may join, and may even receive a notification that the network is now available to join.

The intermediate devices 115a-d and endpoint devices 105a-d (that are configured with the program 204) may form one mesh network using the short-range wireless network (e.g., first wireless network 110a-d) so information (e.g., data 140, message 150) may be transmitted between devices (e.g., endpoint devices 105a-d, intermediate devices 115a-d) within the mesh network using the short-range wireless network (e.g., first wireless network).

In another example, the edge device ED (intermediate device 115a in this example), which receives data 208 (e.g., data collected from IoT device/endpoint device) from an endpoint device 105a may relay or transmit the data 208 to other intermediate devices 115b-d/endpoint devices 105b-d nearby similar to the message 150 above (e.g., using mesh network, using intermediate device-to-intermediate device network, using endpoint device-to-endpoint device network, using intermediate device-to-endpoint device network). This method may be helpful when the intermediate device 115a does not have an access to a second network 120a. Using this method, the data 208 may be relayed to the intermediate device 115d via various routes and transmitted to the endpoint server 135a via the second network 120b. Thus, a “hotspot” service may be provided to the edge device ED (endpoint device 105a and intermediate device 115a in this example) using the program 204 based on the short-range wireless network (e.g., first wireless network 110a-d). Any type of data may be sent to and via the network, including targeted advertisements that are time-based and could also be interest-based. For example, continuing the sports event example from above, an advertisement that could be more applicable to the audience in the stands at the time could be sent, such as for merchandise, or could be for a coupon to the concessions stand at the stadium.

Each of the intermediate devices 115a-s may be configured to listen or detect the beacon signals 140a-d transmitted from surrounding endpoint devices 105a-d. In response to receiving the beacon signals 140a-d, the intermediate devices 115a-d, which detected the beacon signal 140a-d, may send or forward the beacon signals 140a-d to a (corresponding and/or nearby) relay server 125a-b via a second network 120a-b. The first wireless network 110a-d and the second wireless network 120a-b may be different networks (e.g., different network types, different coverage ranges). For example, the first wireless network 110a-d may be a Bluetooth® network or a short-range network and the second wireless network 120a-b may be a cellular network, Wi-Fi®, or the Internet (which may provide a wider coverage than the short-range network).

Each of the relay servers 125a-b may be configured to receive the beacon signals 140a-d from the edge device ED (intermediate device 115a-d in this example) connected via the second network 120a-b. Each of the relay servers 125a-b may be configured to send or forward the beacon signals 140a-d (e.g., beacon signal 140a-d received from the intermediate device 115a-d and/or the endpoint device 105a-d), and/or information (e.g., desired data) related to the beacon signals 140a-d (e.g., unique identification in the beacon signal 140a-d received from the intermediate device 115a-d and/or the endpoint device 105a-d), to an endpoint manager server 135a via a third network 130. In at least one implementation, the second network 120a-b and the third network 130 may be the same network or include at least some overlapping components.

Each of the relay servers 125a-b may include one or more computing devices (such as a rackmount server, a router computer, a server computer, a personal computer, a mainframe computer, a laptop computer, a tablet computer, a desktop computer, smartphone, cars, drones, a robot, any mobility device that has an operating system, etc.), data storage (e.g., hard disks, memories, databases), networks, software components, and/or hardware components.

Each of the relay servers 125a-b may be configured to receive a message 150 from the endpoint manager server 135a. Each of the relay servers 125a-b may be configured to send or forward the message 150 from the endpoint manager server 135a to the intermediate devices 115a-d. Each of the intermediate devices 115a-d may be configured to receive the message 150 and forward the message 150 to the endpoint devices 105a-d.

In some implementations, the endpoint manager server 135a may include one or more computing devices (such as a rackmount server, a router computer, a server computer, a personal computer, a mainframe computer, a laptop computer, a tablet computer, a desktop computer, a smartphone, a car, a drone, a robot, any mobility device that has an operating system etc.), data storage (e.g., hard disks, memories, databases), networks, software components, and/or hardware components. The endpoint manager server 135a may be associated with one or more endpoint devices 105a-d. For example, a particular corporation, person, or manufacturer may sell an endpoint device 105a-d and may use an endpoint manager server 135a to communicate with and/or control the endpoint devices 105a-d.

The endpoint manager server 135a may be configured to send or transmit messages 150 associated with a particular endpoint device 105a-d. For example, the endpoint manager server 135a may be configured to send or transmit updates (e.g., firmware, software, program 204 as discussed above) to the particular endpoint device 105a-d. The endpoint manager server 135a may send other communications to an endpoint device 105a-d, such as a response to a request from a beacon signal 140a-d generated by the particular endpoint device 105a-d.

In some implementations, each of the relay servers 125a-b may include a message manager 142a-b. The message manager 142a-b may be implemented using hardware including a processor, a microprocessor (e.g., to perform or control performance of one or more operations), a field-programmable gate array (FPGA), or an application-specific integrated circuit (ASIC). In some other instances, the message manager 142a-b may be implemented using a combination of hardware and software. Implementation in software may include rapid activation and deactivation of one or more transistors or transistor elements such as may be included in hardware of a computing system (e.g., the relay server 125a-b). Additionally, software defined instructions may operate on information within transistor elements. Implementation of software instructions may at least temporarily reconfigure electronic pathways and transform computing hardware.

Each of the relay servers 125a-b may include a data storage 145a-b. The data storage 145a-b may include any memory or data storage. In some implementations, the data storage 145a-b may include computer-readable storage media for carrying or having computer-executable instructions or data structures stored thereon. The computer-readable storage media may include any available media that may be accessed by a general-purpose or special-purpose computer, such as a processor. For example, the data storage 145a-b may include computer-readable storage media that may be tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may be included in the data storage 145a-b.

The data storage 145a-b is part of the relay server 125a-b. The data storage 145a-b may be separate from the relay server 125a-b and may access the data storage 145a-b via a suitable network. In at least one implementations, the data storage 145a-b may include multiple data storages.

The data storage 145a-b may include data pertaining to the endpoint devices 105a-d, intermediate devices 115a-d, and endpoint manager servers 135a and relationships between the endpoint devices 105a-d, intermediate devices 115a-d, and endpoint manager servers 135a. For example, the data storage 145a-b may include a table or list of endpoint devices 105a-d that are associated with a particular endpoint manager server 135a. The data storage 145a-b may include data pertaining to beacon signals 140a-d received from endpoint devices 105a-d, such as a timestamp of the receipt of the beacon signal 140a-d, a timestamp associated with the creation of the beacon signal 140a-d, a geo-location associated with the beacon signal 140a-d and/or the endpoint device 105a-d that created or transmitted the beacon signal 140a-d, sensor data associated with the endpoint device 105a-d, routing information for how and/or where to send data between endpoint manager servers 135a and endpoint devices 105a-d, connection strengths between intermediate devices 105a-d and endpoint devices, proximity of an endpoint device 105a-d to an intermediate device 115a-d, type of first wireless network 110a-d that connects an intermediate device 115a-d and an endpoint device 105a-d, a cost of a connection between an intermediate device 115a-d and an endpoint device 105a-d, a current battery level of the intermediate device, a type of intermediate device 115a-d, etc.

In some implementations, the message manager 142a-b may process communications between the endpoint devices 105a-d, the intermediate devices 115a-d, and the endpoint manager server(s) 135a. In an example, the message manager 142a-b may receive a beacon signal 140a-d from the intermediate device 115a-d via the second network 120a-b. The beacon signal 140a-d may have been sent to the intermediate device 115a-d via the first wireless network 110a-d by endpoint device 105a-d. In some implementations, the beacon signal 140a-d may contain characteristics about the endpoint device 105a-d, including an identifier of the endpoint device 105a-d (e.g., MAC address, unique identification), a geographical location of the endpoint device 105a-d, and advertisements of the UUIDs of the services it supports, etc. The message manager 142a-b may identify the characteristic of the beacon signal 140a-d, such as by analyzing the beacon signal 140a-d to identify information pertaining to the beacon signal 140a-d. The message manager 142a-b may access the data storage 145a-b to identify, based on the characteristic of the beacon signal 140a-d, an endpoint manager server 135a that is associated with the beacon signal 140a-d. For example, the identifier of the endpoint device 105a-d may be associated with a particular manufacturer that operations a particular endpoint manager server 135a. The message manager 142a-b may identify this particular endpoint manager server 135a in the data storage 145a-b and an address and/or path to send the beacon signal 140a-d in order to reach the endpoint manager server 135a. In at least some implementations, the message manager 142a-b may send the beacon signal 140a-d, or a beacon message to the endpoint manager server 135a via the third network 130. The beacon message may include the beacon signal 140a-d, may not include the beacon signal 140a-d, or may include information pertaining to the beacon signal 140a-d.

A beacon signal 140a-d may include data from multiple services associated with the endpoint device 105a-d. Additionally or alternatively, multiple beacon signals 140a-d from a single endpoint device 105a-d may be generated and broadcast via the first wireless network 110a-d. Each of these multiple beacon signals 140a-d, for example, may be associated with a different service associated with the endpoint device 105a-d. The message manager 142a-bmay identify the services, and based on information for the service, identify an appropriate endpoint manager server 135a that may receive a beacon signal 140a-d.

The endpoint manager server 135a may be configured to receive the beacon signal 140a-d (e.g., message) from the relay server 125a-b. The endpoint manager server 135a may store the beacon signal 140a-d, process the beacon signal 140a-d, generate a report based on the beacon signal 140a-d, may generate a notification or response based on the beacon signal 140a-d, or any other action. For example, the endpoint manager server 135a may generate a response message 150 pertaining to the beacon signal 140a-d. The response message 150 may include a message 150 intended for one or more of the relay server 125a-b, an intermediate device 115a-d, the endpoint device 105a-d that generated the beacon signal 140a-d, or another endpoint device 105a-d that did not generate the beacon signal 140a-d. The endpoint manager server 135a may send the response message to the same relay server 125a-b that sent the beacon signals 140a-d to the endpoint manager server 135a, or to a different relay server 125a-b that did not send the beacon message to the endpoint manager server 135a.

The relay server 125a-b may receive, from the endpoint manager server 135a, the response message 150 pertaining to the beacon signal 140a-d. The relay server 125a-b may process the response message 150, such as by performing operations at the relay server 125a-b, sending data to another device (e.g., a user device), sending data to an endpoint device 105a-d, etc.

The network architecture 100 may be used to exchange data between any devices capable of network-based communication in a manner that is different than conventional communication over the Internet.

As illustrated in FIG. 2a, the example network architecture 200a may include an intermediate device 115e that is configured with the virtual environment 202e (e.g., virtualization environment, containerization environment). Once the program 204 is received by the intermediate device 115e, the program 204 may be ready to execute or run on the virtual environment 202e to fulfill a specific mission. In some implementations, the program 204 includes at least one unique identification of the desired endpoint device 105e (e.g., media access control (MAC) address associated with the desired endpoint device 105e, universally unique identifier (UUID) associated with the desired endpoint device 105e) to determine the event that triggers the execution of the program 204 (e.g., determining that the intermediate device 115e is within the communication range of the desired endpoint 105e, detecting a beacon signal from the endpoint device 115e). The network architecture 100 in FIG. 2a may include a cloud server 200 including relay servers, 125c-d and an endpoint manager server 135b.

Referring to the network architecture 200b in FIG. 2b, in some circumstances, the intermediate device 115e is movable. When the intermediate device 115e is moving, the intermediate device 115e may listen or detect the beacon signals (e.g., listening mode) from nearby endpoint devices 105e periodically or randomly. Based on the received beacon signals (e.g., a beacon signal with a unique identifier of the desired endpoint device 105e), the intermediate device 115e may determine when the intermediate device 115e is within the communication range of the desired endpoint device 105e via a first network 110e. The intermediate device 115e may forward the beacon signals to the relay servers 125c-d and/or the endpoint manager server 135b and wait for a (confirm) message from the relay servers 125c-d and/or the endpoint manager server 135b (as illustrated in FIG. 2A). The intermediate device 115e may determine when the intermediate device 115e is within the communication range of the desired endpoint device 105e. More than one intermediate device 115e may be provided with the program 204. More than one unique identifier of the desired endpoint 105e may be included in the program 204 when there is more than one target endpoint device 105e. The endpoint device 105e may be configured to transmit the beacon signals upon receiving a particular signal (e.g., a beacon signal, a query signal, or the like) from an intermediate device 115e.

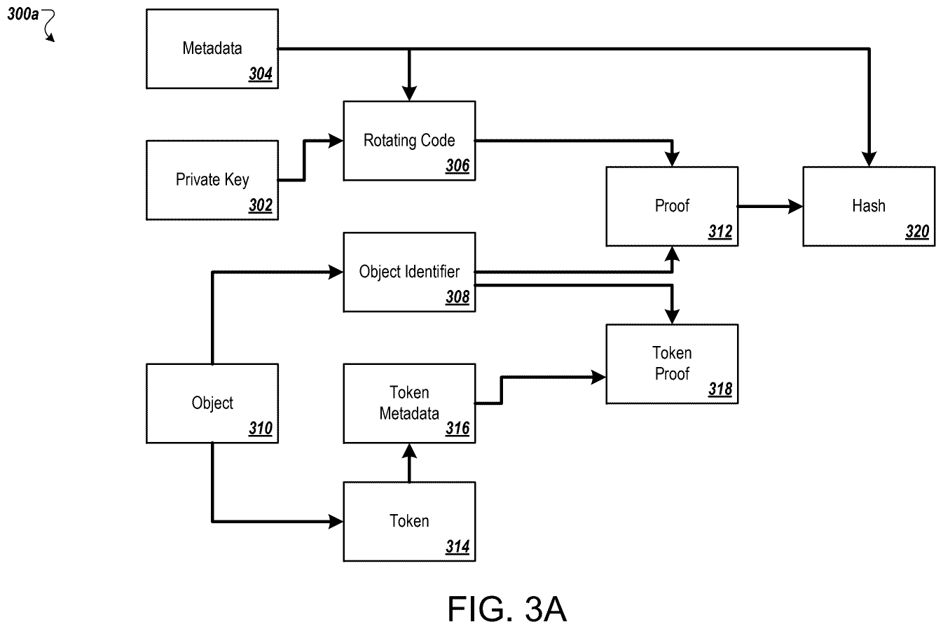

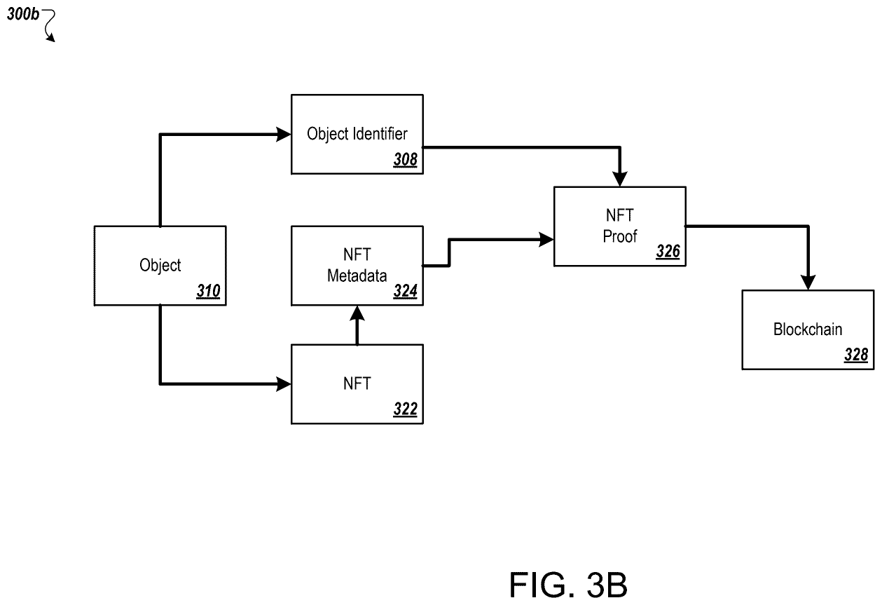

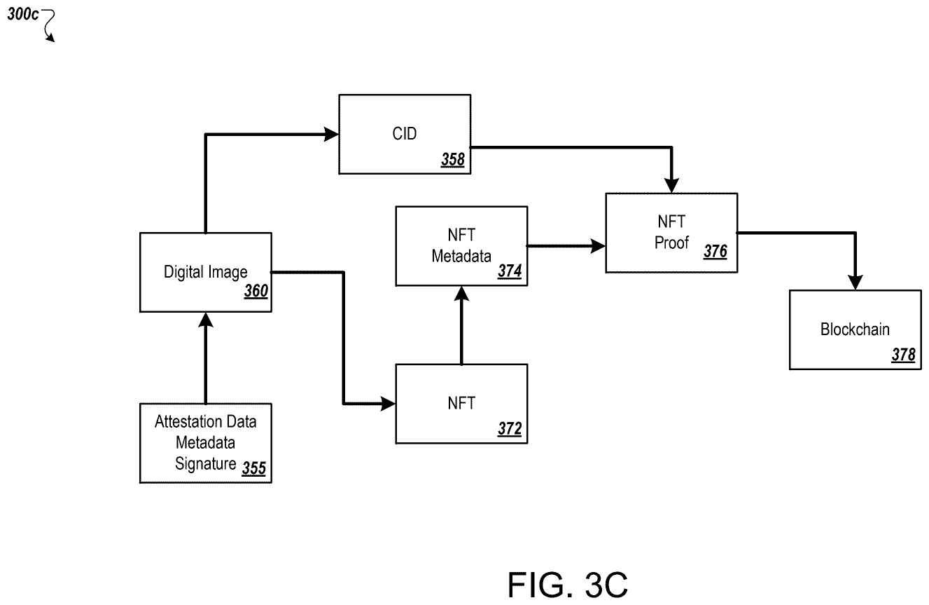

Referring to the network architecture 200c in FIG. 2c, in some circumstances, when the intermediate device 115e determines that the intermediate device 115e is within the communication range of the desired endpoint 105e (e.g., matching between the unique identifier in the beacon signal and the unique identification in the program 204), the program 204 on the intermediate device 115e may be executed to transmit a request to obtain the desired data (e.g., a rotating code) from the desired endpoint device 105e. In response to the request from the intermediate device 115e, the desired endpoint 105e may transmit the desired data (e.g., a rotating code 306, as provided in FIG. 3A) to the intermediate device 115e. The intermediate device 115e may be configured to store the data in its storage. The intermediate device may be configured to transmit the desired data to a second network 120c.

Referring to the network architecture 200d in FIG. 2D, the intermediate device 115e (which may include the program 204) may be configured to transmit the data to the cloud server 200 when the second network 120c (e.g., Wi-Fi®, cellular network) is available to the intermediate device 115e.

The network architecture 100, 200a-d as provided in FIG. 1 and FIGS. 2A-2D may be used for object validation. Validation may be facilitated by computing a proof (e.g., a proof of connectivity, proof of participation, location, time, object origin/authenticity, environmental conditions, or the like). A device for object validation may include data processing hardware and memory hardware in communication with the data processing hardware. The memory hardware may store instructions that when executed on the data processing hardware may cause the data processing hardware to perform operations. As illustrated in the functionality 300a in FIG. 3A, the operations may include one or more of: generating a rotating code 306 by combining a private key 302 with metadata 304. The operations may include computing a proof 312 using the rotating code 306 and an object identifier 308 for an object 310. The operations may include generating a hash 320 of the proof 312 and the metadata 304; or storing the hash 320 in a network-accessible storage device.

A private key 302, or a symmetric key, may be combined with metadata 304 to generate a rotating code 306. The private key 302, or a symmetric key, may be any suitable private key 302, or a suitable symmetric key, that may be combined with metadata 304 to generate a rotating code 306. The private key 302, or a symmetric key, may include one or more of: a private signature key, a symmetric authentication key, a private authentication key, a symmetric data encryption key, a symmetric key wrapping key, a symmetric master key, a private key transport key, a symmetric key agreement key, a private static key agreement key, a private ephemeral key agreement key, a symmetric authorization key, a private authorization key, or the like.

The private key 302, or a symmetric key, may be combined with the metadata 304. The metadata 304 may include one or more of: a timestamp, a location, a date, a file size, an author, event (e.g., a calendar event), directional orientation (e.g., north, west, east, south, or the like), annotation (e.g., text, tags, or the like), or the like. In one example, the timestamp may be a current time and the private key 302, or a symmetric key, may be combined with the current time to generate the rotating code 306.

The private key 302, or a symmetric key, may be combined with the metadata 304 to generate the rotating code 306 using any suitable technique. In one example, a hash function may be used to generate a rotating code 306 using the private key 302 (or the symmetric key) and metadata 304. The hash function may be any suitable hash function for generating a rotating code 306 such as, e.g., secure hash algorithm 1 (SHA-1), message-digest algorithm (MD5), Research and Development in Advanced Communications Technologies in Europe (RACE) integrity primitives evaluation message digest (RIPEMD)-128/60, or the like. The rotating code 306 may be generated by truncating the output when the hash function is used to combine the private key 302 (or the symmetric key) and the metadata 304. When the metadata 304 is a current time, the rotating code 306 may be generating by applying the hash function to the private key 302 and the current time (e.g., a timestamp).

The rotating code 306 may be any suitable variable code that may be generated using a private key 302 (or a symmetric key) and metadata 304. For example, the rotating code 306 may be a 6 digit code that may be generated using the timestamp and the private key 302 (or a symmetric key). For example, when an object 310 is set up (e.g., by a client), a private key 302 may be loaded on the object 310. This private key 302 may be shared with the client and the object 310 and may not be known to other entities. The rotating code 306 may be generated by combining the private key 302 and metadata (e.g., a current time). This code may be valid for a selected time window.

The rotating code 306 may be used with an object identifier 308 for an object to compute a proof 312 (e.g., a proof of connectivity, location, time, object origin/authenticity, environmental conditions, or the like). The object 310 may be any suitable object 310 that may be used for proof of connectivity, proof of participation, proof of location, proof of time, proof of object origin, proof of object authenticity, proof of environmental condition, or the like. That is, for an example of proof-of-connectivity, the proof 312 may be the combination of the object identifier 308 (e.g., a unique object identifier (UOID)) and the rotating code 306 (e.g., a 6-digit code). The proof 312 may be valid for a selected period of time associated with the rotating code 306.

The object identifier 308 may be used to identify the object 310 using any suitable data type (e.g., floating-point, integer, or the like). For example, the object identifier 308 may include one or more of: a UOID or a content identifier (CID) (e.g., for a digital image). In an example of proof of connectivity, the client may own an object 310 (e.g., a smart object) which may be configured to compute cryptographic primitives. The object 310 may have a UOID that may be broadcast using one or more of: (i) a short-range wireless protocol (e.g., Bluetooth® or Bluetooth® Low Energy (BLE)), or (ii) a displayed quick response (QR) code that may be scanned.

One or more hashes 320 of the proof 312 and the metadata 304 may be generated. For example, one or more hashes 320 associated with an object 310 may be computed for the object 310 for the time period of e.g., a smart contract. One or more hashes 320 of the plurality of hashes 320 may be computed by generating one or more hashes using the proof 312 and a current time to facilitate the generation of a plurality of hashes over a selected time period. The one or more hashes 320 may be stored in a network-accessible storage device. For example, the one or more hashes may be published to a distributed file system (e.g., on an InterPlanetary File System (IPFS)) that may be accessible by a contract (e.g., a smart contract).

The object 310 may be configured to transmit one or more of the rotating code 306 or the object identifier 308 within a selected communication range of the object 310. One or more of the rotating code 306 or the object identifier 308 may be received by an intermediate device 115a-e (as illustrated in FIGS. 1 and 2A-2D) via one or more of a wired network, a wireless network, a QR code, or the like.

The intermediate device 115a-e may include data processing hardware and memory hardware in communication with the data processing hardware. The memory hardware may store instructions that when executed on the data processing hardware may cause the data processing hardware to perform operations including receiving a rotating code 306 and an object identifier 308 for an object 310. When the intermediate device 115a-e is within a selected communication range of the object 310, the intermediate device 115a-e may be configured to listen to the broadcast from the object 310 which includes one or more of the rotating code 306 or the object identifier 308. The intermediate device 115a-e may be configured to receive the rotating code 306 (e.g., a 6 digit code) and the object identifier 308 (e.g., a UOID). The intermediate device 115a-e may be configured to compute a proof 312 using the object identifier 308 and the rotating code 306. The intermediate device 115a-e may be configured to compute a hash 320 of the proof 312 and metadata 304 (e.g., a current time). The intermediate device 115a-e may be configured to send the hash 320 to a server for verification of the proof 312.

Object validation may be used with various kinds of connections between nodes (e.g., items, services, devices, accounts, events, or people). A network 100, 200a-d (as illustrated in FIGS. 1 and 2A-2D) may be configured to connect two or more nodes (e.g., items, services, devices, accounts, events, or people). The connection may be a link between two or more devices (e.g., between an intermediate device 115a-e and an endpoint device 105a-e). The connection may be between an account (e.g., associated with a user) and a device (e.g., an end point device 105a-e). The connection may be between two or more of the devices in the network 100, 200a-d (e.g., 105a-e, 111a-e, 115a-e, 125a-b, 135a, etc.), which may be configured to identify a lost or severed connection and restore the connection between the nodes (e.g., an item and another item, an owner of an item, a user account, or the like). Two or more of the nodes in the network 100, 200a-d may create a temporary connection between, e.g., a device or user account with a particular event or with other people.

To assist with connectively and/or with rewarding various activities on the network 100, 200a-d, proof-of-connectivity may be used. When a network 100, 200a-d is a decentralized network, smart contracts holding a reward may be unlocked upon receiving a proof 312 (e.g., a proof of connectivity). A proof 312 may be used for implementing a trustless process for providing funds to an intermediate device 115a-e. An object 310 (e.g., associated with an endpoint device 105a-e) may be associated with a smart contract. In one example, a pre-payment may be sent to a smart contract which may include details for a bounty associated with the smart contract. In one example, an intermediate device 115a-e may determine when a bounty is associated with the hash 320 and send the proof 312 (e.g., a proof of connectivity) to a smart contract. The proof 312 may be encrypted using a public key for the smart contract. The smart contract may be configured to verify that the proof 312 is valid and, in response to the verification, release the bounty associated with the smart contract to the intermediate device 115a-e.

Alternatively or in addition, one or more tokens (e.g., cryptographic tokens) may be used to facilitate object validation. A device (e.g., associated with a client) may be configured to generate one or more tokens 314 (e.g., a non-fungible token (NFT)) based on an object 310. The device may be configured to generate a token proof 318 (e.g., an NFT proof) using token metadata (e.g., NFT metadata) and the object identifier 308 for the object 310. The device may be configured to push the token proof to a suitable data storage device. When the token is an NFT, the device may be configured to push the NFT proof to a blockchain. The object 310 may be any suitable object that may be linked to a token such as digital art, videogame assets, music, film, or the like. In one example, the object 310 may be a digital image.

An intermediate device 115a-e (as illustrated in FIGS. 1 and 2A to 2D) may be configured to send, on the blockchain, an NFT proof for an object 310 to receive a bounty. The intermediate device 115a-e may receive cryptocurrency and/or a different digital asset (e.g., a different NFT) based on submitting a proof-of-connectivity (which may be validated using the NFT proof or may be validating using a different cryptographic proof). When the network 100, 200a-d (as illustrated in FIGS. 1 and 2A-D) is a decentralized network, the smart contract may be trustless. That is, a device (e.g., associated with a client) may not: (i) receive the proof-of-connectivity from the intermediate device 115a-e without providing the bounty to the intermediate device 115a-e, and (ii) the intermediate device 115a-e may not use inaccurate data to receive the bounty from the device (e.g., associated with a client).

Proof of connectivity may be used in various use cases such as object tracking, increasing location foot traffic, event participation, performance participation, micro-messaging, or the like. An intermediate device 115a-e may be configured to communicate with a network 100, 200a-d to facilitate proof of connectivity. In some cases, the intermediate device 115a-e may not communicate directly with a chain and may not reserve the bounty. The intermediate device 115a-e may be configured to communicate directly to an endpoint manager server 135a (e.g., a Nodle Service Provider (“NSP”)) that may manage access to the network 100, 200a-d. The endpoint manager server 135a may receive payment in fiat currency (e.g., USD, EUR) which may carry the risk of cryptocurrency price volatility. The endpoint manager server 135a may be configured to provide application protocol interfaces and/or user interfaces to facilitate access to the network. A device (e.g., associated with a client) may be configured to connect to the network 100, 200a-d using the endpoint manager server 135a.

Proof of connectivity may be used for object tracking, e.g., for a physical object. When an intermediate device 115a-e connects to the object, the intermediate device 115a-e may receive a reward (e.g., cryptographic tokens) by sending the proof-of-connectivity (e.g., as hash or as a token proof) to a network 100, 200a-d (as illustrated in FIGS. 1 and 2A-D).

For example, a company who manages a fleet of vehicles may track those vehicles using Bluetooth® beacons that may be installed in the tracked vehicles by registering the tracked vehicles on the network 100, 200a-d. The company may provide a reward (e.g., cryptocurrency) for the vehicle location over a selected period of time. When an intermediate device 115a-e receives one or more of the rotating code 306 or an object identifier 308 from the Bluetooth® beacon on the tracked vehicle, the intermediate device 115a-e may be configured to send the encrypted location of the tracked vehicles to the network 100, 200a-d to receive the reward. The intermediate device 115a-e may be configured to compute a proof 312 using the object identifier 308 and the rotating code 306 to generate a hash of the proof 312 and metadata 304. The intermediate device 115a-e may be configured to send the hash of the proof 312 (e.g., the proof of connectivity) and the metadata 304 for verification of the proof 312. The intermediate device 115a-e may send an address for receiving the reward.

Proof of connectivity may be used for increasing foot traffic to a particular location. An intermediate device 115a-e (as illustrated in FIGS. 1 and 2A-2D), when located within a communication distance of an endpoint device 105a-e (e.g., a Bluetooth beacon), may receive one or more of the rotating code 306 or the object identifier 308 from the endpoint device 105a-e, which may be located at a particular location such as a retail location. The intermediate device 115a-e may be configured to compute a proof 312 using the rotating code and an object identifier (e.g., a universal unique identifier (UUID) for a Bluetooth® beacon or a UOID for an object). A hash 320 of the proof 312 and metadata 304 (e.g., a current time) may be generated. The hash 320 may be sent for verification to a network 100, 200a-d. The intermediate device 115a-e may be configured to receive a reward (e.g., in cryptocurrency) for providing proof of connectivity at the particular location.

For example, a restaurant may want to attract customers for lunch. An endpoint device 105a-e (as illustrated in FIGS. 1 and 2A-2D) may be located at the restaurant location. An application (e.g., the Nodle Cash app) may be used to create a “Place Mission” to assign cryptocurrency as an associated bounty (e.g., with a reward in cryptocurrency) in the Mission escrow for the first 20 participants. There may be a cryptocurrency fee to create a mission in the application. When the Mission is active and, in some instances, when the restaurant's Nodle Cash app is opened, people with the Nodle Cash app in the same city may be notified that there is an ongoing mission to go to the restaurant for lunch.

The restaurant may have a device at the restaurant (e.g., an endpoint device 105a-e as illustrated in FIGS. 1 and 2A-2D) that may broadcast a rotating code 306 using Bluetooth®. The rotating code may be combined with an object identifier 308 for the endpoint device 105a-e to compute a proof 312, which may be combined with metadata 304 (e.g., a current time) to generate a hash 320. The hash 320 may be used by the Nodle Cash app to prove that the intermediate device 115a-e (and an associated user) were in the vicinity (e.g., a communication distance of the endpoint device 105a-e) of the restaurant. Alternatively, or in addition, the proof 312 may be provided using a QR code which may be scanned by an intermediate device 115a-e. The QR code may be combined with an object identifier 308 to compute a proof 312. The proof 312 may be combined with metadata 304 to compute a hash 320, which may be sent to a network 100, 200a-d for verification of the proof 312. Alternatively or in addition, the QR code may be the proof 312 and the QR code may be combined with metadata 304 to generate a hash 320 which may be sent to the network 100, 200a-d for verification of the proof 312. When the maximum number of participants has been reached (which is 20 participants in this scenario), the bounty may be depleted and the mission may be ended.

Proof of connectivity may be used to increase foot traffic and to provide rewards based on additional proof-of-connectivity. For example, a retail coffee company may want to increase traffic at their coffee shops. The coffee company may provide an endpoint device 105a-e (as illustrated in FIGS. 2A-2D) to broadcast, e.g., a Bluetooth® signal. People with a specific application (e.g., a Nodle Cash app) in the vicinity of the coffee shops (e.g., a communication distance of the Bluetooth® signal) may collect the digital badge and use the digital badge to buy coffee. The retail coffee company may use the specific application (e.g., a Nodle Web app) to create a mission for the retail coffee locations. The missions may be created for a fee.

For the retail coffee company example, an intermediate device 115a-e may be used to establish proof of connectivity. The intermediate device 115a-e may be configured to identify an object identifier 308 (e.g., an identifier broadcast by the Bluetooth® signal) for an object 310 (e.g., the coffee shop). The intermediate device 115a-e may be configured to generate a token (e.g., an NFT) 314 based on the object 310. Token metadata 316 (e.g., NFT metadata) may be combined with the object identifier 308 to generate a token proof 318 (e.g., an NFT proof). The NFT proof 318 may be pushed to a blockchain to verify proof of connectivity for the intermediate device 115a-e. Alternatively or in addition, a token (e.g., an NFT) may be provided to the intermediate device 115a-e which may be used to buy coffee at the coffee shops. The tokens (e.g., NFTs) may be tracked to provide further rewards after a selected number of tokens (NFTs) have been used.

Proof-of-connectivity may be used with tokens to facilitate increased functionality. For example, a conference organizer or sponsor may want to provide a conference experience in which attendees may use a token to: (i) receive admission to the conference, (ii) receive rewards at the conference, and (iii) receive access to media pertaining to the conference. When the attendees purchase a ticket, the attendees may receive a token 314 (e.g., an NFT) from the conference organizer/sponsor on an application (e.g., a Nodle app wallet). The token 314 (e.g., an NFT) may include a cryptocurrency allowance. The token 314 (e.g., NFT) may have an associated rotating code 306. Alternatively or in addition, the token 314 (e.g., NFT) may have one or more of a QR code representation or Beacon ID representation. The rotating code 306 may allow the token 314 (e.g., NFT): (i) to facilitate admission to the conference, (ii) to receive a reward (e.g., cryptocurrency) to purchase food during the conference, and (iii) to provide access to digital media (e.g., a private off-chain board that may include chat or other social media) about the conference. The token 314 (e.g., NFT) may be used for proof-of-connectivity when the token 314 (e.g., NFT) is scanned at the conference. Scanning the token 314 (e.g., NFT) may facilitate the transfer of a reward (e.g., cryptocurrency) to a digital wallet for the attendee.

Proof of connectivity may be used for a social network. The network 100, 200a-d (as illustrated in FIGS. 1 and 2A-D) may be used to create a social network, which may be based on a proximal social graph of the devices (e.g., endpoint devices 105a-e and intermediate devices 115a-e in the network 100, 200a-d) as well as based on users of those devices. Such a proximal social network that may be leveraged by any code (e.g., 204) executed on devices.

With a sports event example, a proximal and temporal social network may be created for fans in the stadium. Multiple proximal social networks may also be created within a geographical range, such as one for each team that is playing at the sport event, and for any number of other interest groups. In some examples, the social networks may be predefined. Additionally or alternatively, a social network may be created based on input received via one or more of the devices (e.g., endpoint devices 105a-e and intermediate devices 115a-e in the network 100, 200a-d). In some examples, social networks may be created based on user input or may be subject to one or more filters that may prevent certain types of social networks from being created.

A social network may be accessed by any device (e.g., endpoint devices 105a-e and intermediate devices 115a-e in the network 100, 200a-d) that has either a proof 312 or an NFT 322 associated with the social network. Additionally or alternatively, a location may be used so that the device may be at or near a particular location. Within the social network, users may chat with each other without one or more of: (i) sharing any personal information, (ii) sending or accepting any friend requests, or (iii) having to search for a link. Users of the social network may remain anonymous while also getting the benefit of interacting with like-minded people who may be looking to interact with others.

Proof-of-connectivity may be used to provide payment. That is, to receive proof-of-connectivity, an intermediate device 115a-e (as illustrated in FIGS. 1 and 2A-2D) may send payment to an endpoint device 105a-e. For example, a street performer may want to be paid for playing guitar when people like her music. The street performer may use an application (e.g., the Nodle Cash app) to create an activity (e.g., an “Activity labeled “Guitar Street performance) at a specific location. People listening to the music may receive a token (e.g., an NFT) when in a communication distance of an endpoint device 105a-e associated with the street performer. When the activity is active, and when the performers' application (e.g., Nodle Cash app) is active, people with the application (e.g., Nodle Cash app) in a communication distance of the endpoint device 105a-e may be notified that there is an ongoing activity with the price in cryptocurrency for receiving the a proof of connectivity. The street performer's endpoint device 105a-e may broadcast a Bluetooth® signal including a rotating code. People with the application (e.g., Nodle Cash app) who are listening to the performance may receive a notification about a minimum donation amount (e.g., request for payment) and, when the people pay the minimum amount or more, then they may receive the proof-of-participation token 314 (e.g., NFT). In response, the endpoint device (e.g., associated with the street performer) may receive the donation amounts (e.g., in cryptocurrency) from people who have donated when the performance has finished.

Proof-of-connectivity may be used for various smart contracts. For example, proof-of-connectivity may be used in micro-messaging. For example, a person may challenge a participant to do an activity (such as a “dare”) in the presence of a witness to receive cryptocurrency. For example, a Student may challenge a Friend to eat the spiciest food of his life, and she is willing to pay a particular amount of cryptocurrency. The Student may create the challenge using an application (e.g., the Nodle app) and provide the reward in cryptocurrency. The challenge may have a specified time limit and allow for the selection of a participant (e.g., the Friend) and a Witness. The Friend may receive a notification on the application and agree to participate and the Witness (which may include one or more people) may receive a notification on the application and agree to be a Witness. The bounty may be sent to the smart contract. The Friend may submit the result of the challenge to the Student and the Witness. The Witness may approve the result to unlock the fund. In this example, the Witness may issue the proof 312. The proof 312 may be computed using an object identifier 308 and a rotating code 306. Alternatively or in addition, the proof 312 may be a token (e.g., an NFT). The intermediate device 115e may be configured to generate a token (e.g., an NFT) 314. Token metadata 316 (e.g., NFT metadata) may be combined with the object identifier 308 to generate a token proof 318 (e.g., an NFT proof). The token proof 318 (e.g., NFT proof) may be pushed to a blockchain to verify proof of connectivity for the intermediate device 115a-e.

Proof of connectivity may be used to verify that a product or service is the correct product or service. For example, a user may hail a vehicle using a ride sharing application. The driver of the vehicle may issue a proof 312 or token proof 318 (e.g., an NFT) that may be broadcast. When the user approaches the vehicle, the intermediate device 115e may receive one or more of the proof 312 or the token proof 318. One or more of the proof 312 or the token proof 318 may be used to confirm that the vehicle is the correct vehicle. On the intermediate device 115a-e, information (e.g., data) about the vehicle may be displayed based on one or more of the proof 312 or the token proof 318 (e.g., the NFT) such as one or more of a make, model, or confirmation that the vehicle is the correct vehicle.

An NFT 322 may be used for object validation as illustrated in the functionality 300b in FIG. 3B. A device for object validation may include data processing hardware; and memory hardware in communication with the data processing hardware. The memory hardware may store instructions that when executed on the data processing hardware may cause the data processing hardware to perform operations. The operations may include one or more of identifying an object identifier 308 for an object 310; generating an NFT 322 based on the object 310; generating an NFT proof 326 using NFT metadata 324 and the object identifier 308; or pushing the NFT proof 326 to a blockchain 328.

Alternatively or in addition, a proof 312 may be computed using one or more of an object identifier 308 or a rotating code 306, as illustrated in FIG. 3A. A hash 320 may be generated using the proof 312 and metadata 304 and the hash 320 may be stored in a network-accessible storage device. The proof 312 may be used in combination with the NFT 322 to increase the level of the proof when compared to the proof 312 or the NFT 322, individually.

As illustrated in FIG. 3B, the object 310 may include an object identifier 308. When the object 310 is a digital image, the object identifier may be a content identifier (CID) for the digital image. The object 310 may be associated with metadata which may include one or more of a proof of location at a selected time and a selected place, a proof of connectivity, or a proof of origin. When the object 310 is a digital image, the proof of location at a selected time and a selected place may include when the digital image was captured and where the digital image was captured. When the object 310 is a digital image, the proof of connectivity may include proof that a particular person captured the digital image. When the object 310 is a digital image, the proof of origin may include proof that the digital image was captured by a particular camera.

Before an NFT 322 is generated based on an object 310, attestation data may be inserted into the object. The attestation data may include one or more of nearby device data, sensor data, network data, biometric data, additional imaging data, or the like. An NFT 322 may be generated based on the object 310. NFT metadata 324 for the NFT 322 may be combined with the object identifier 308 to generate an NFT proof 326. The NFT proof 326 may be pushed to a blockchain 328. The NFT proof 326 may be used to verify one or more of an object time, an object location, an object origin, or the like. The NFT proof 326 may be an NFT CID.

As illustrated in FIG. 3C, functionality 300c for facilitating NFT proof 376 for a digital image 360 is provided. A device (e.g., an endpoint device 105a-e or an intermediate device 115a-e as illustrated in FIGS. 1 and 2A-D) for digital image proof may include data processing hardware, and memory hardware in communication with the data processing hardware. The memory hardware may store instructions that when executed on the data processing hardware may cause the data processing hardware to perform operations. The operations may include identifying a digital image 360 (e.g., using a CID 358 for the digital image 360). The digital image 360 may include attestation data as a root of trust for generating a digital image NFT (e.g., NFT 372), as shown in block 355. In one example, the attestation data may be generated using an image attestation standard (e.g., a Content Authenticity Initiative (CAI) standard, a Coalition for Content Provenance and Authenticity (C2PA) standard, or the like).

The digital image 360 may be captured using any suitable device (e.g., a digital camera). When the digital image 360 is captured, one or more of a signature or an attestation data (as shown in block 355) may be added to the digital image 360. One or more of the signature, the attestation data, or metadata (e.g., EXIF metadata), as shown in block 355, may be added to the raw image file. The digital image data may be signed using one or more of a public key or a wallet address. The metadata may include verified location using a proof of interaction or a third party application on a network 100. In one example, the verified location may be obtained using Bluetooth® low energy (BLE). In one example, different kinds of metadata may be included such as date of digital image capture, time of digital image capture, an identifier associated with a customer or client for the digital image, a location name, a calendar event, an orientation of the digital image (e.g., north, south, east, west), specific measurements of the area, or other annotations (e.g., text, tags, drawing, voice memo, translated voice memos, or the like).

Attestation data may be provided to the digital image 360 before generating an NFT 372. The attestation data may include any data suitable for attestation including one or more of: nearby device data (e.g., data from different devices within a selected distance (e.g., 10 m, 20 m, 50 m, 1000 m, 1 mile, or the like) of the device that may be used to determine a reality metric, sensor data (e.g., motion data, temperature data, humidity data, or environmental data), network data (e.g., cloud data), biometric data (e.g., fingerprints, facial, voice, iris, palm, or the like), or additional imaging data (e.g., digital image data from outside of the range of the digital image 360, e.g., capturing a three dimensional field scan of an image and attaching it to the digital image 360).

During the capture and upload process, attestation data may be added to verification of the digital image 360 that may previously include attestation data. For example, a digital image 360 may previously include attestation data using a standard (e.g., CAI or C2PA). Additional attestation data may be added to the previous attestation data to increase an attestation level (CAI standard attestation with sensor attestation data) relative to a baseline situation in which attestation is provided without the additional attestation data (e.g., CAI standard without sensor attestation data). In some examples, additional data may be added to the digital image (e.g., that the digital image was edited using a digital image editing program, such as Photoshop® or Lightroom®).

An NFT 372 may be generated based on the digital image 360. The operations may include receiving a CID 358) for the digital image 360. The CID 358 may be received by pushing one or more of the digital image 360, the metadata, the attestation data, or the signature to a distributed file system (e.g., Interplanetary File System (IPFS)). An NFT Proof 376 (e.g., an NFT CID) may be received based on NFT metadata 374 and the CID 358 for the digital image 360. An image attestation status may be requested from a network and the network may check when image attestation has been uploaded before or has a different provenance.

The NFT proof 376 may be pushed to the blockchain 378. The NFT proof 376 may include the NFT CID (e.g., CID of NFT metadata). After the NFT proof 376 has been pushed to the blockchain, attestation for the NFT may be added. For example, CAI attestation may be added showing that the NFT has been minted. Consequently, the image NFT may be verified using a standard (e.g., a CAI standard) and/or open source code as authentic. A source of the NFT content (e.g., brands, camera makers, content creators) may be provided to a party using a bidirectional communication channel.

The NFT may be distributed using various methods. In one example, a distribution and/or licensing for the NFT may be selected. That is, the NFT may be sent, traded, or sold on a decentralized marketplace. A distribution option may be selected upon uploading the NFT. In one example, the distribution options may include one or more of: (i) a public domain distribution option may be selected in which, e.g., a select number of prints in which the creator retains ownership may be selected, (ii) a select number of NFT owners, (iii) a select number of uses for NFT owners, (iv) an unlimited number of licenses, or the like.

Attestation for the digital image may be added or verified. An attestation may be added (e.g., using a CAI standard or a different attestation standard) to a non-attested digital image. The attestation standard (e.g., CAI standard or non-CAI standard) may be used to verify that a digital image is authentic, to verify provenance for the digital image, or to verify a creator for the digital image. When a CAI standard has not been used, a digital image may be uploaded that has been attested using a non-CAI standard.

Verification data may be generated using a combination of first verification and second verification data (e.g., first and second proofs). The first verification data may include attestation data based on a first standard and the second verification data may include data captured when the digital image is captured. The operations may include combining a plurality of proofs to create a combined proof that is stronger than each individual proof.

A server may be configured to generate NFT 372 to facilitate proof of a digital image 360. The server (e.g., an endpoint manager server 135a as illustrated in FIG. 1) may include data processing hardware; and memory hardware in communication with the data processing hardware. The memory hardware may store instructions that when executed on the data processing hardware may cause the data processing hardware to perform operations. The operations may include identifying, at the server, a digital image 360. The operations may include identifying, at the server, a CID 358 for the digital image 360. The operations may include generating, at the server, an NFT 372 based on the digital image 360. The operations may include identifying, at the server, an NFT proof 376 (e.g., an NFT CID) based on NFT metadata 374 and the CID 358 for the digital image 360. The operations may include pushing the NFT proof 376 (e.g., NFT CID) to a blockchain 378.

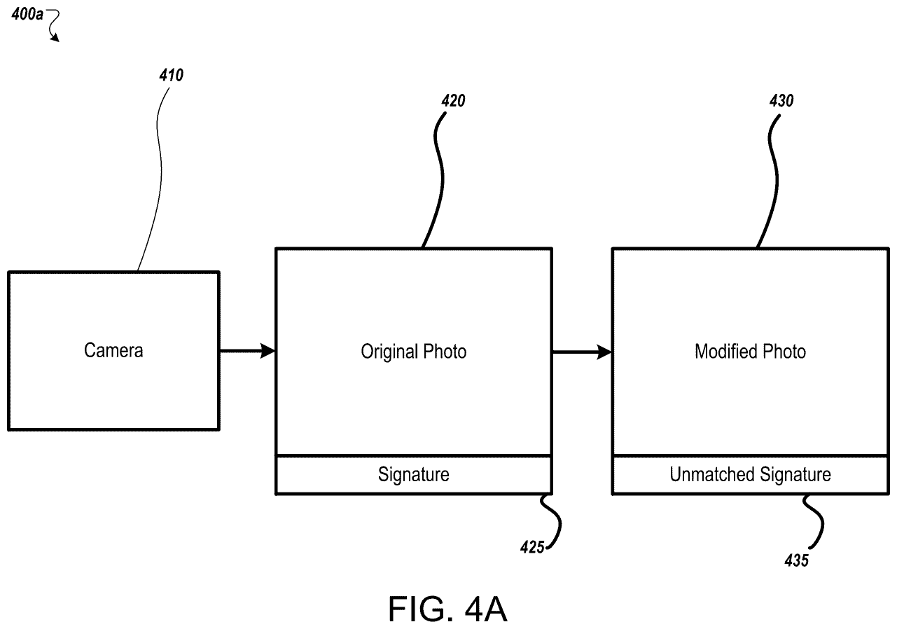

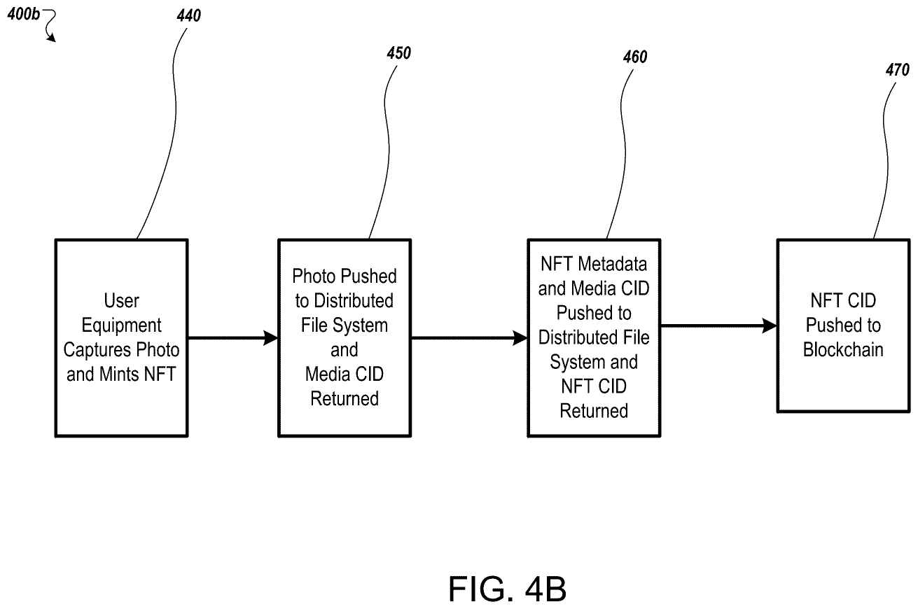

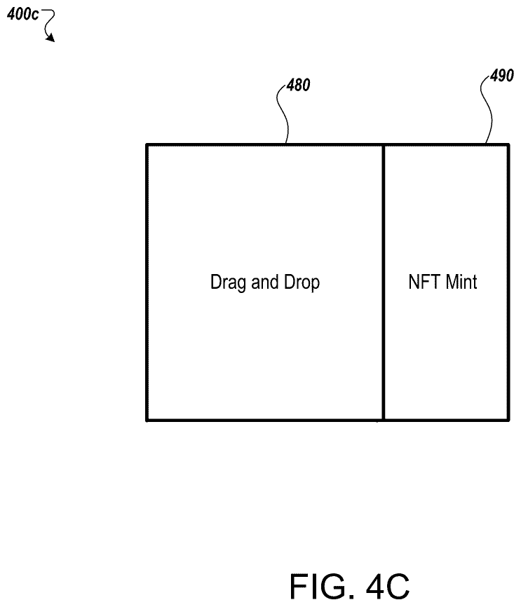

The signature for the original photo may be used to authenticate a digital image as an original. As illustrated in FIG. 4A, a block diagram 400a for digital image verification shows a camera 410 (e.g., a digital camera) that may be configured to capture a digital image, sign the digital image, and include metadata with the digital image. The camera 410 (e.g., a digital camera) may be configured to include the signature 425 for the original photo 420. The signature 425 may indicate that the original photo 420 is authentic. When the original photo 420 has been modified to generate a modified photo 430, then the modified photo 430 may include an unmatched signature 435.

An NFT may be used to verify the authenticity of a digital image. As shown in the process flow 400b in FIG. 4B, a device (e.g., a wireless device such as a wireless digital camera) may be configured to capture a digital image (e.g., a photo) that includes an attestation record (e.g., an attestation record based on a CAI standard or a non-CAI standard) and generate an NFT based on the digital image, as shown in block 440. The device may capture the digital image as a raw image file that may be signed. The signature may be included in the exchangeable image file (EXIF) metadata associated with the digital image.

The signature of the raw file, additional metadata (e.g., for a time or place of capture or the like), attestation data, or the like may be pushed to a blockchain. That is, the device may be configured to push the digital image including the attestation record to a distributed file system (e.g., IPFS) and receive a media CID for the digital image, as shown in 450. The raw image file may be stored offline, on the distributed file system (e.g., IPFS) or on decentralized storage. The device may be configured to push NFT metadata and the media CID (e.g., the digital image CID) to the distributed file system (e.g., IPFS) and receive an NFT CID, as shown in 460. The device may be configured to push the NFT CID to a blockchain, as shown in 470.

When a device is connected to a network, a number of digital images may be selected to be minted as NFTs or digital images may be minted as NFTs to be claimed by a user. Upon NFT minting, payment may be provided to one or more of a device manufacturer (e.g., a camera manufacturer), a blockchain owner, or the like.

The digital image may be attested (e.g., as a C2PA marked digital image) and pushed on-chain to generate an NFT, as illustrated in FIG. 4C. The digital image may be captured using a wireless device (e.g., an iPhone®) or a device in communication with a wireless device that may be configured to attach attestation data (e.g., C2PA metadata) to the digital image. In another example, the digital image may be processed to have NFT metadata included in the digital image format.

A user interface 400c (e.g., for a web browser, a smart phone, a tablet, or the like) may include various operations. A digital image file may be dragged and dropped onto the display area 480 and the digital image file may be used to generate an NFT (e.g., minting an NFT as shown in the display area 490) based on the digital image. For example, a digital image that has been attested using an attestation standard (e.g., C2PA) may be minted into an NFT using the user interface 400c. The drag-and-drop functionality and the NFT generation functionality may be supported natively as a background function (e.g., for iOS® or for Android®). When the digital image file does not include an attestation record (e.g., a C2PA record), then an attestation record (e.g., a C2PA record) may be added to the digital image file. An attestation record software development kit (SDK) or application protocol interface (API) may be used to attach an attestation record to the digital image file.

A digital image viewer may be configured to add support for attestation data (e.g., C2PA metadata) when viewing the digital image. The digital image viewer may be configured to support numerous aspect ratios (e.g., square aspect ratios, rectangular aspect ratios, or the like. Branding or a source of the specific digital camera used to capture the digital image may be included in the digital image that may be displayed using the digital image viewer. Additional metadata (e.g., as stored using exchangeable image file format (EXIF) such as, “Shot on Leica® M11 f1.8 1/100^{th} s. ISO 32”) may be displayed using the digital image viewer. The digital image viewer may be configured to allow the attestation record (e.g., the C2PA attestation record) to be viewed. The NFT associated with the digital image may be used to verify the digital image. The digital image viewer may be configured to display whether the digital image was captured natively using the same device or whether the digital image was copied from another source (e.g., uploaded). The digital image may be uploaded to a digital image viewer that may natively support verification.

Modifications, additions, or omissions may be made to the network architecture 100 without departing from the scope of the present disclosure. The present disclosure more generally applies to the network architecture 100, 200a-d including one or more endpoint devices 105a-e, one or more wireless networks 110a-d, one or more intermediate devices 115a-e, one or more second networks 120a-b, one or more relay servers 125a-b, one or more third networks 130, and one or more endpoint manager servers 135a or any combination thereof.

Moreover, the separation of various components in the implementations described herein is not meant to indicate that the separation occurs in all implementations. In addition, it may be understood with the benefit of this disclosure that the described components may be integrated together in a single component or separated into multiple components.

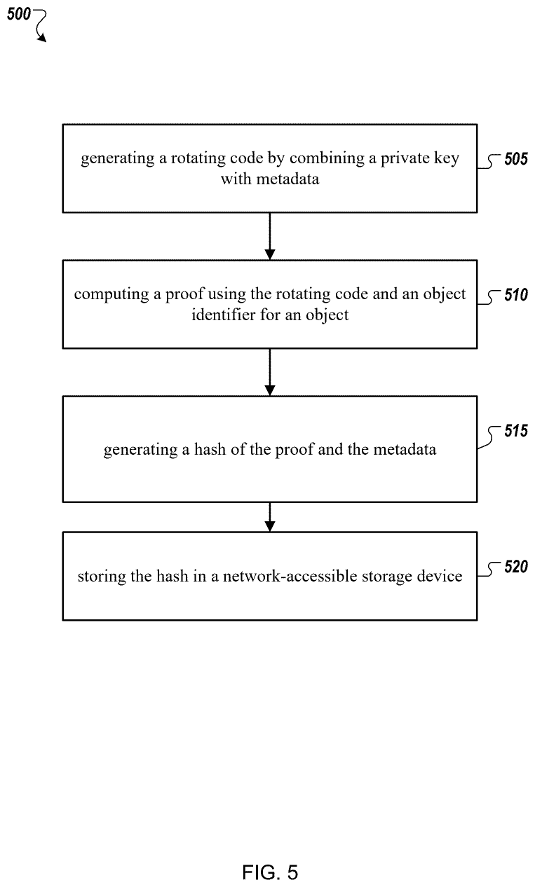

FIG. 5 is a flowchart 500 of an example arrangement of operations for a method of object validation. The method 500 may be performed by processing logic that may include hardware (circuitry, dedicated logic, etc.), software (such as is run on a general purpose computer system or a dedicated machine), or a combination of both, which processing logic may be included in any computer system or device. The software (also referred to as program 204 in this disclosure) may be instructions or code capable of running on a virtualization environment and/or containerization environment such as bytecode and containerized program

The method 500, at operation 505, includes generating a rotating code by combining a private key with metadata. At operation 510, the method 500 may include computing a proof using the rotating code and an object identifier for an object. At operation 515, the method 500 may include generating a hash of the proof and the metadata. At operation 520, the method 500 may include storing the hash in a network-accessible storage device.

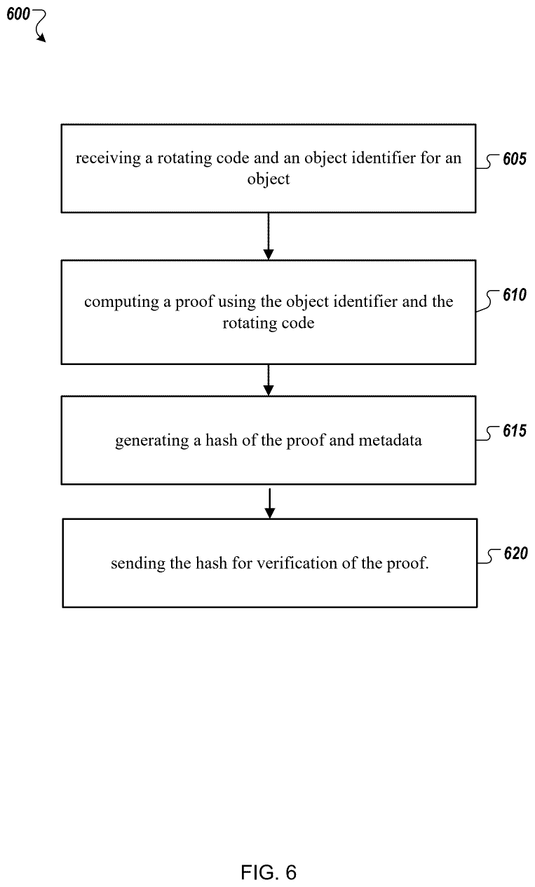

FIG. 6 is a flowchart 600 of an example arrangement of operations for a method of object validation. The method 600 may be performed by processing logic that may include hardware (circuitry, dedicated logic, etc.), software (such as is run on a general purpose computer system or a dedicated machine), or a combination of both, which processing logic may be included in any computer system or device. The software (also referred to as program 204 in this disclosure) may be instructions or code capable of running on a virtualization environment and/or containerization environment such as bytecode and containerized program

The method 600, at operation 605, includes receiving a rotating code and an object identifier for an object. At operation 610, the method 600 may include computing a proof using the object identifier and the rotating code. At operation 615, the method 600 may include generating a hash of the proof and metadata. At operation 620, the method 600 may include sending the hash for verification of the proof.

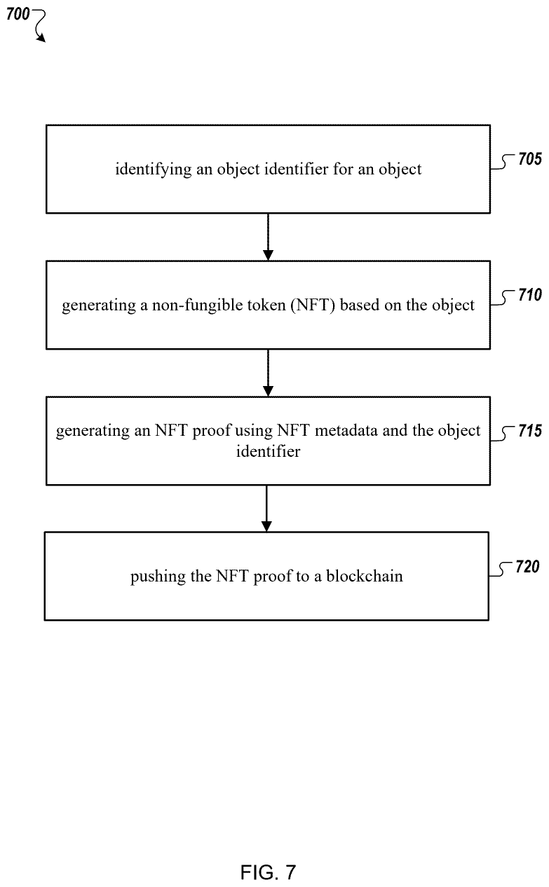

FIG. 7 is a flowchart 700 of an example arrangement of operations for a method of object validation. The method 700 may be performed by processing logic that may include hardware (circuitry, dedicated logic, etc.), software (such as is run on a general purpose computer system or a dedicated machine), or a combination of both, which processing logic may be included in any computer system or device. The software (also referred to as program 704 in this disclosure) may be instructions or code capable of running on a virtualization environment and/or containerization environment such as bytecode and containerized program

The method 700, at operation 705, includes identifying an object identifier for an object. At operation 710, the method 700 may include generating a non-fungible token (NFT) based on the object. At operation 715, the method 700 may include generating an NFT proof using NFT metadata and the object identifier. At operation 720, the method 700 may include pushing the NFT proof to a blockchain.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

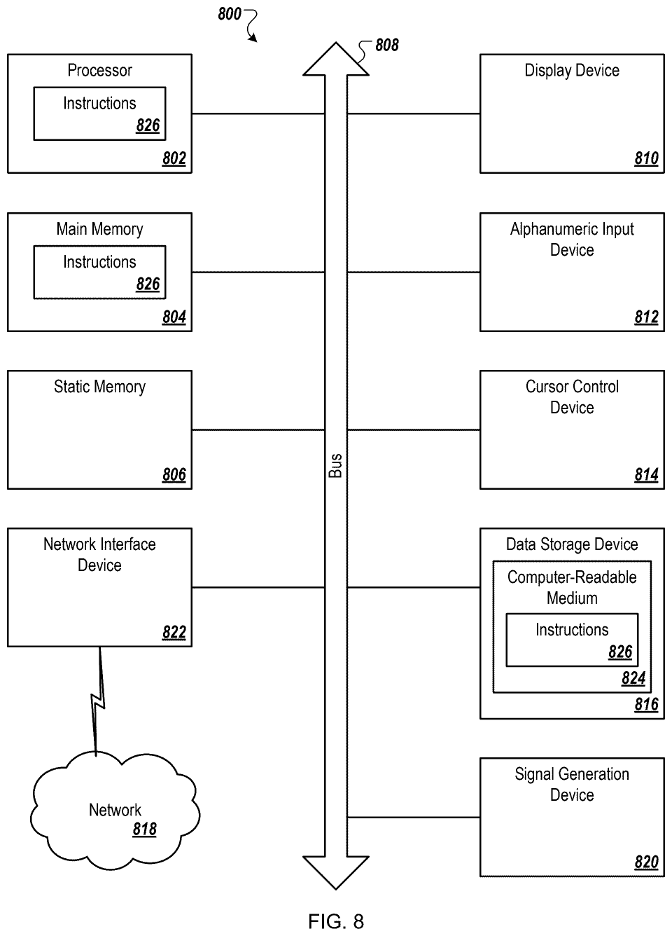

FIG. 8 is a schematic view illustrating a machine in the example form of a computing device 800 within which a set of instructions, for causing the machine to perform any one or more of the methods discussed herein, may be executed. The computing device 800 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The example computing device 800 includes a processing device (e.g., a processor) 802, a main memory 804 (e.g., read-only memory (ROM), flash memory, dynamic random access memory (DRAM) such as synchronous DRAM (SDRAM)), a static memory 806 (e.g., flash memory, static random access memory (SRAM)) and a data storage device 816, which communicate with each other via a bus 808.

Processing device 802 represents one or more general-purpose processing devices such as a microprocessor, central processing unit, or the like. More particularly, the processing device 802 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also include one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein.

The computing device 800 may further include a network interface device 822 which may communicate with a network 818. The computing device 800 also may include a display device 810 (e.g., a liquid crystal display (LCD) or a cathode ray tube (CRT)), an alphanumeric input device 812 (e.g., a keyboard), a cursor control device 814 (e.g., a mouse) and a signal generation device 820 (e.g., a speaker). In at least one implementation, the display device 810, the alphanumeric input device 812, and the cursor control device 814 may be combined into a single component or device (e.g., an LCD touch screen).

The data storage device 816 may include a computer-readable storage medium 824 on which is stored one or more sets of instructions 826 embodying any one or more of the methods or functions described herein. The instructions 826 may also reside, completely or at least partially, within the main memory 804 and/or within the processing device 802 during execution thereof by the computing device 800, the main memory 804 and the processing device 802 also constituting computer-readable media. The instructions may further be transmitted or received over a network 818 via the network interface device 822.

While the computer-readable storage medium 826 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used herein and especially in the appended claims (e.g., bodies of the appended claims) are generally intended as “open” terms (e.g., the term “including” may be interpreted as “including, but not limited to,” the term “having” may be interpreted as “having at least,” the term “includes” may be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases may not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” may be interpreted to mean “at least one” or “one or more”); the same holds true for the use of definite articles used to introduce claim recitations.

In addition, even if a specific number of an introduced claim recitation is explicitly recited, those skilled in the art will recognize that such recitation may be interpreted to mean at least the recited number (e.g., the bare recitation of “two recitations,” without other modifiers, means at least two recitations, or two or more recitations). Further, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, may be understood to contemplate the possibilities of including one of the terms, either of the terms, or both terms. For example, the phrase “A or B” may be understood to include the possibilities of “A” or “B” or “A and B.”

Implementations described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some implementations, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although implementations of the present disclosure have been described in detail, it may be understood that the various changes, substitutions, and alterations may be made hereto without departing from the spirit and scope of the present disclosure.

What is claimed is:

1. A device for object validation, comprising:
data processing hardware; and
memory hardware in communication with the data processing hardware, the memory hardware storing instructions that when executed on the data processing hardware cause the data processing hardware to perform operations comprising:
generating a rotating code by combining a private key with metadata;
computing a proof using the rotating code and an object identifier for an object;
generating a hash of the proof and the metadata; and
storing the hash in a network-accessible storage device.

2. The device of claim 1, wherein the code includes one or more of: a timestamp, a location, or an origin.

3. The device of claim 1, wherein the object identifier comprises one or more of: a unique object identifier (UOID) or a content identifier for a digital image (CID).

4. The device of claim 1, wherein the proof is one or more of: a proof of location at a selected time and a selected place, a proof of connectivity, or a proof of origin.

5. The device of claim 1, wherein the instructions, when executed on the data processing hardware, cause the data processing hardware to perform operations comprising:
generating a non-fungible token (NFT) based on the object;
generating an NFT proof using NFT metadata and the object identifier for the object; and
pushing the NFT proof to a blockchain.

6. The device of claim 5, wherein the object is a digital image.

7. A device for object validation, comprising:
data processing hardware; and
memory hardware in communication with the data processing hardware, the memory hardware storing instructions that when executed on the data processing hardware cause the data processing hardware to perform operations comprising:
receiving a rotating code and an object identifier for an object;
computing a proof using the object identifier and the rotating code;
generating a hash of the proof and metadata; and
sending the hash for verification of the proof.

8. The device of claim 7, wherein the metadata includes one or more of: a timestamp, a location, or an origin.

9. The device of claim 7, wherein the object identifier comprises one or more of: a unique object identifier (UOID) or a content identifier for a digital image (CID).

10. The device of claim 7, wherein the proof is one or more of: a proof of location at a selected time and a selected place, a proof of connectivity, or a proof of origin.

11. The device of claim 7, wherein the instructions, when executed on the data processing hardware, cause the data processing hardware to perform operations comprising:
sending, on a blockchain, a non-fungible token (NFT) proof for the object.

12. The device of claim 11, wherein the object is a digital image.

13. A device for object validation, comprising:
data processing hardware; and
memory hardware in communication with the data processing hardware, the memory hardware storing instructions that when executed on the data processing hardware cause the data processing hardware to perform operations comprising:
identifying an object identifier for an object;
generating a non-fungible token (NFT) based on the object;
generating an NFT proof using NFT metadata and the object identifier; and
pushing the NFT proof to a blockchain.

14. The device of claim 13, wherein the object comprises proof that is one or more of: a proof of location at a selected time and a selected place, a proof of connectivity, or a proof of origin.

15. The device of claim 13, wherein the instructions, when executed on the data processing hardware, cause the data processing hardware to perform operations comprising:
inserting attestation data to the object before generating the NFT, wherein the attestation data includes one or more of: nearby device data, sensor data, network data, biometric data, or additional imaging data.

16. The device of claim 13, wherein the instructions, when executed on the data processing hardware, cause the data processing hardware to perform operations comprising:
verify one or more of an object time, an object location, or an object origin based on the NFT proof.

17. The device of claim 13, wherein the NFT proof is an NFT content identifier (CID).

18. The device of claim 13, wherein the object is a digital image and the object identifier is a content identifier (CID) for the digital image.

19. The device of claim 13, wherein the instructions, when executed on the data processing hardware, cause the data processing hardware to perform operations comprising:
compute a proof using the object identifier and a rotating code.

20. The device of claim 19, wherein the instructions, when executed on the data processing hardware, cause the data processing hardware to perform operations comprising:
generating a hash of the proof and metadata; and
storing the hash in a network-accessible storage device.
